(19) United States
(12) Patent Application Publication
(10) Pub. No.: US 2026/0114622 A1
(43) Pub. Date: Apr. 30, 2026

(54) ADJUSTABLE CHAIR

(71) Applicant: MERITS HEALTH PRODUCTS CO., LTD., Taichung City (TW)

(72) Inventors: Ming-Chuan CHENG, Taichung City (TW); Shun-Yuan CHENG, Taichung City (TW)

(21) Appl. No.: 19/270,446

(22) Filed: Jul. 15, 2025

(30) Foreign Application Priority Data
Oct. 30, 2024 (TW) 113141514

(51) Int. Cl. A47C 1/024; A47C 1/03; A47C 7/46

(52) U.S. Cl. CPC A47C 1/0246; A47C 1/0308; A47C 7/462

(57) ABSTRACT

An adjustable chair includes a chair base, a backrest frame, a backrest plate and two armrest structures. The backrest frame is pivotally disposed on the chair base, wherein the backrest frame includes two side panels. The backrest plate is movably disposed on the backrest frame. The two armrest structures are respectively pivotally connected to the two side panels, and each of the two armrest structures includes a fixing plate, a pin, a stabilizing element and an armrest bracket. The fixing plate is fixedly disposed on one of the two side panels and includes a pivoted hole. The pin element passes through and is disposed in the pivoted hole. The pin element is disposed in the stabilizing element. The armrest bracket is locked and connected to the pin element.

### RELATED APPLICATIONS

This application claims priority to Taiwan Application Serial Number 113141514, filed Oct. 30, 2024, which is herein incorporated by reference.

### BACKGROUND

### Technical Field

The present disclosure relates to a chair. More particularly, the present disclosure relates to an adjustable chair including an armrest structure.

### Description of Related Art

With the prevalence of health awareness, the ergonomics becomes more and more important to people. The conventional chair structure includes a chair base, a backrest and armrests, wherein the backrest is disposed on the chair base, the armrests are disposed on the backrest, and the chair can be adjusted to a reclining position so that the backrest can be tilted backwards. Further, because the position of the hands may be different between different persons when lying down or sitting, the armrests can be further adjusted so as to meet the ergonomics.

However, the adjusting method of the armrests can only be achieved by manually adjusting the armrests by the user, and for the person with hand disability, the armrests cannot be adjusted in this method. Therefore, there is still room for improvement the present problem.

### SUMMARY

According to one aspect of the present disclosure, an adjustable chair includes a chair base, a backrest frame, a backrest plate and two armrest structures. The backrest frame is pivotally disposed on the chair base, wherein the backrest frame includes two side panels. The backrest plate is movably disposed on the backrest frame. The two armrest structures are respectively pivotally connected to the two side panels, and each of the two armrest structures includes a fixing plate, a pin, a stabilizing element and an armrest bracket. The fixing plate is fixedly disposed on one of the two side panels and includes a pivoted hole. The pin element passes through and is disposed in the pivoted hole. The stabilizing element is sleeved and disposed on the pin element. The armrest bracket is locked and connected to the pin element. When the backrest frame rotates relative to the chair base at a first angle, the two armrest structures respectively rotate relative to the chair base at a second angle, and the second angle of each of the two armrest structures is smaller than the first angle.

According to another aspect of the present disclosure, an adjustable chair includes a chair base, a backrest frame and two armrest structures. The backrest frame is pivotally disposed on the chair base, wherein the backrest frame includes two side panels. The two armrest structures are respectively pivotally connected to the two side panels, and each of the two armrest structures includes a fixing plate, a pin element, a stabilizing element and an armrest bracket. The fixing plate is fixedly disposed on one of the two side panels and includes a pivoted hole. The pin element passes through and is disposed in the pivoted hole. The stabilizing element is sleeved and disposed on the pin element, and the stabilizing element has an elasticity. The armrest bracket is locked and connected to the pin element. When the stabilizing element is forced and deformed by the pin element, the backrest frame rotates relative to the chair base at a first angle, each of the two armrest structures is driven to rotate relative to the backrest frame at a second angle, and the second angle of each of the two armrest structures is smaller than the first angle.

### BRIEF DESCRIPTION OF THE DRAWINGS

The present disclosure can be more fully understood by reading the following detailed description of the embodiment, with reference made to the accompanying drawings as follows:

FIG. 1 is a schematic view of an adjustable chair according to one embodiment of the present disclosure.

FIG. 2 is a partial exploded view of the adjustable chair of FIG. 1.

FIG. 3 is an exploded view of an armrest structure of the adjustable chair of FIG. 1.

FIG. 4 is a cross-sectional view of the adjustable chair of FIG. 1 along Line 4-4.

FIG. 5 is a side schematic view of the adjustable chair of FIG. 1.

### DETAILED DESCRIPTION

The present disclosure will be further exemplified by the following specific embodiments with the drawings so as to facilitate utilizing and practicing the present disclosure completely by the people skilled in the art without over-interpreting and over-experimenting. However, the readers should understand that the present disclosure should not be limited to these practical details thereof, that is, in some embodiments, these practical details are used to describe how to implement the materials and methods of the present disclosure and are not necessary. Furthermore, in order to simplify the drawings, some conventional structures and elements will be illustrated in a simple manner in the drawings, and the repeated elements may be represented by the same reference numerals.

Further, the terms of “first”, “second” and “third” are only for illustrating different elements or components and not used to limit the elements or components themselves. Thus, the first element/component can be named as the second element/component. Furthermore, the combination of the elements/component/structures/modules described in the present specification are not well-known, conventional or common combination in the field, and it is hard for the person skilled in the arts to determine whether the combination relationship is obviousness or not based on the elements/components/structures/modules themselves are conventional or not.

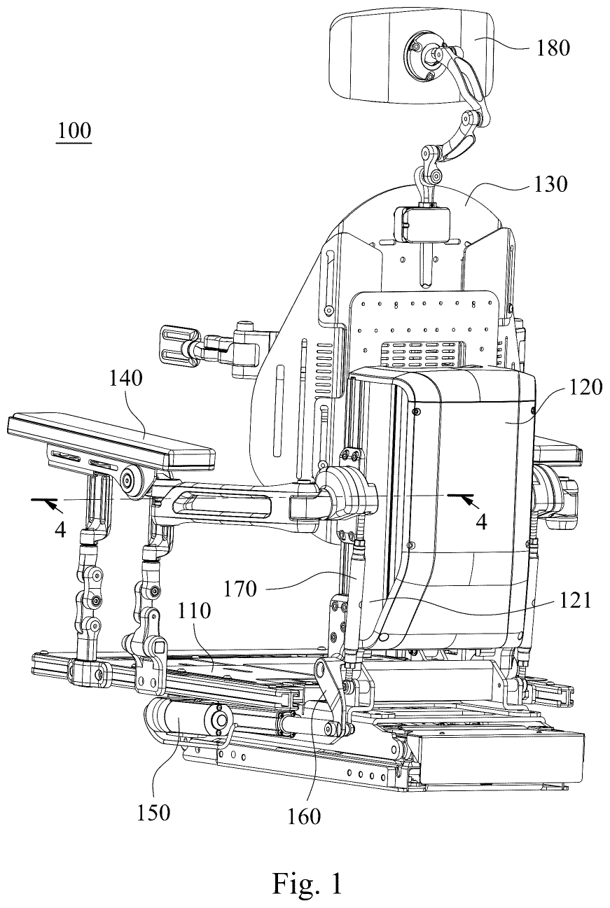

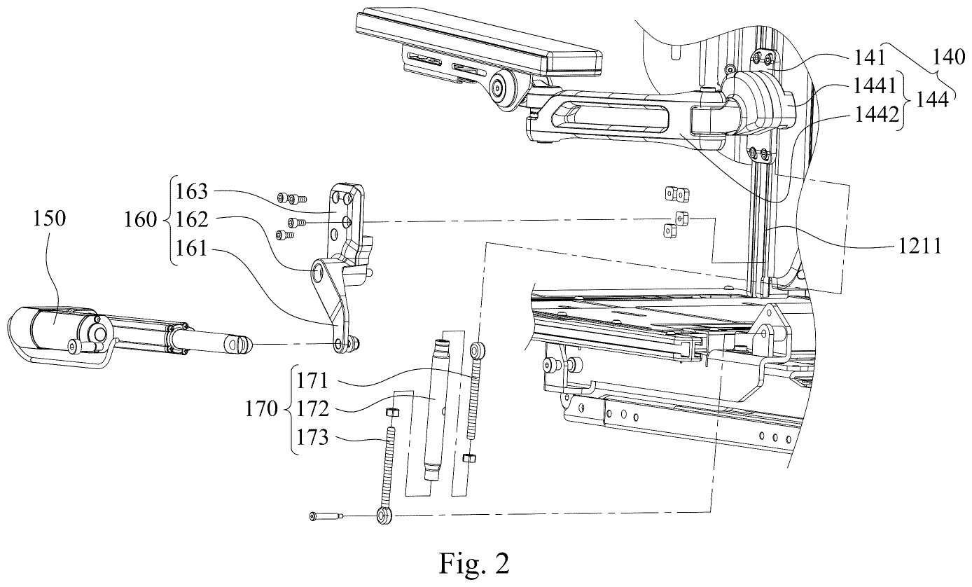

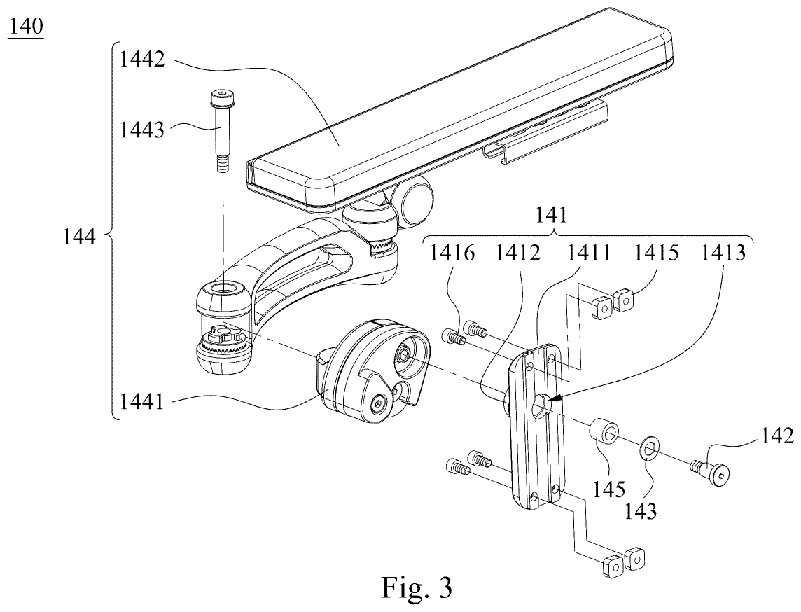

Reference is made to FIG. 1 to FIG. 3, wherein FIG. 1 is a schematic view of an adjustable chair 100 according to one embodiment of the present disclosure, FIG. 2 is a partial exploded view of the adjustable chair 100 of FIG. 1, and FIG. 3 is an exploded view of an armrest structure 140 of the adjustable chair 100 of FIG. 1. The adjustable chair 100 includes a chair base 110, a backrest frame 120, a backrest plate 130 and two armrest structures 140.

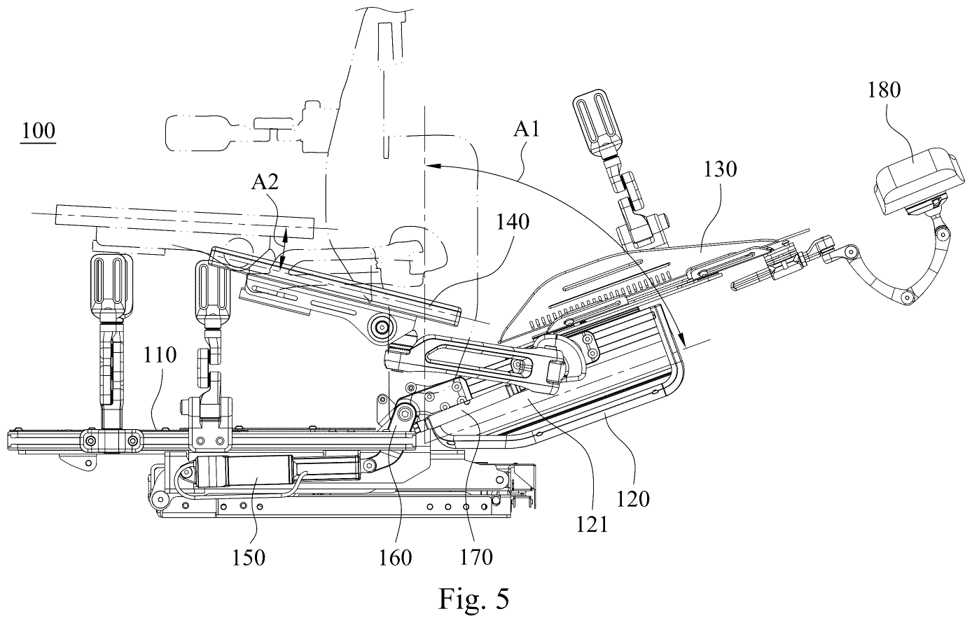

The backrest frame 120 is pivotally disposed on the chair base 110 and includes two side panels 121. The two armrest structures 140 are respectively pivotally connected to the two side panels 121, and each of the two armrest structures 140 includes a fixing plate 141, a pin element 142, a stabilizing element 143 and an armrest bracket 144. The fixing plate 141 is fixedly disposed on one of the two side panels 121 and includes a pivoted hole 1414. The pin element 142 passes through and is disposed in the pivoted hole 1414. The stabilizing element 143 is sleeved and disposed on the pin element 142. The armrest bracket 144 is locked and connected to the pin element 142. When the backrest frame 120 rotates relative to the chair base 110 at a first angle A1 (reference number is shown in FIG. 5), the two armrest structures 140 respectively rotate relative to the chair base 110 at a second angle A2 (reference number is shown in FIG. 5), and the second angle A2 of each of the two armrest structures 140 is smaller than the first angle A1.

In particular, the chair base 110 is substantially a rectangular plate body, and the backrest frame 120 is substantially a box shape, wherein the backrest frame 120 is pivotally disposed on a rear portion of the chair base 110, and the backrest plate 130 is movably disposed on a side of the backrest frame 120 near the chair base 110 so as to serve as a backrest for a user. The adjustable chair 100 can further include a headrest 180. The headrest 180 is disposed on an upper portion of the backrest plate 130, and the position and the angle of the headrest 180 can be adjusted so as to meet the needs of the user. It must be noted that the adjustable chair 100 of the present disclosure can include a wheelchair structure (not shown), so the adjustable chair 100 can further include a base frame and a plurality of wheels. The chair base 110 can be disposed on the base frame, the number of the wheels can be four, and the four wheels can be disposed under the base frame. Further, for the simplicity of the drawings, the base frame and the wheels are omitted in the figures, but the present disclosure is not limited thereto. Further, in other embodiments, the adjustable chair 100 also can be a chair with a conventional structure and include a plurality of chair legs, but the present disclosure is not limited thereto.

As shown in FIG. 1 and FIG. 2, the adjustable chair 100 can further include a driving element 150 and a driving rod 160. The driving element 150 is disposed on the chair base 110. The driving rod 160 is connected to the driving element 150 and one of the two side panels 121. The driving element 150 drives the driving rod 160 to drive the backrest frame 120 to rotate relative to the chair base 110.

The driving element 150 can be an electric cylinder and include a push rod (not shown in the figures), and the driving rod 160 can includes a bent rod portion 161, a central portion 162 and a driving portion 163. The push rod is pivotally disposed on one end portion of the bent rod portion 161, and the other end portion of the bent rod portion 161 is integrally disposed on the central portion 162. The central portion 162 is pivotally disposed on chair base 110, one end portion of the driving portion 163 is integrally disposed on the central portion 162, and the other end portion of the driving portion 163 is disposed on one of the side panels 121. When the push rod is retracted, the driving rod 160 can pivot clockwise with the central portion 162 as a fulcrum. At this time, the driving portion 163 drives the one of the two side panels 121 to drive the backrest frame 120 and the backrest plate 130 to lie back relative to the chair base 110. When the push rod is extended, the driving rod 160 can pivot counterclockwise with the central portion 162 as a fulcrum. At this time, the driving portion 163 drives the one of the two side panels 121 to drive the backrest frame 120 and the backrest plate 130 to stand upright relative to the chair base 110.

The adjustable chair 100 can further include a backrest plate 130, and the backrest plate 130 is movably disposed on the backrest frame 120. The adjustable chair 100 can include a connecting link assembly (not shown in the figures), and the connecting link assembly is pivotally connected to the backrest frame 120 and the backrest plate 130 and is pivotally disposed on the chair base 110. When the driving element 150 operates to drive the backrest frame 120 to rotate, the backrest plate 130 can move relative to the backrest frame 120. Accordingly, when adjusting the backrest frame 120 to tilt relative to the chair base 110, the backrest plate 130 can be moved to fit the back of the user, so that it is favorable for preventing the back of the user from pulling by external force so as to enhance the using comfort of the adjustable chair 100 of the present disclosure.

The following description is based on one side of the adjustable chair 100, but the present disclosure is not limited thereto. As shown in FIG. 1 and FIG. 3, the side panel 121 can include two rails 1211, and the fixing plate 141 can further include a plate body 1411, two sliding portions 1415 and two fixing elements 1416. The two sliding portions 1415 are connected to the plate body 1411 and respectively accommodated in the two rails 1211, and the two fixing elements 1416 respectively pass through the plate body 1411 and are locked in the two sliding portions 1415.

The two rails 1211 are concavely disposed on a surface of the side panel 121, and a length extension direction of each of the two rails 1211 is parallel to a length extension direction of the side panel 121. In the present embodiment, a number of the sliding portion 1415 and a number of the fixing element 1416 can be both four, and each of the sliding portions 1415 is a square block and has a screw hole structure at the center thereof, wherein two of the sliding portions 1415 are located on one of the rails 1211, and the other two of the sliding portions 1415 are located on the other of the rails 1211. Each of the fixing elements 1416 can include a screw element, and four of the fixing elements 1416 respectively pass through the four corner portions of the plate body 1411 and then lock into the four sliding portions 1415 so as to lock the plate body 1411 on the side panel 121. It must be noted that when the fixing element 1416 is loosened, the armrest structure 140 including the fixing plate 141 can be driven to slide along the length extension direction of the rail 1211 so as to adjust the position of the armrest structure 140.

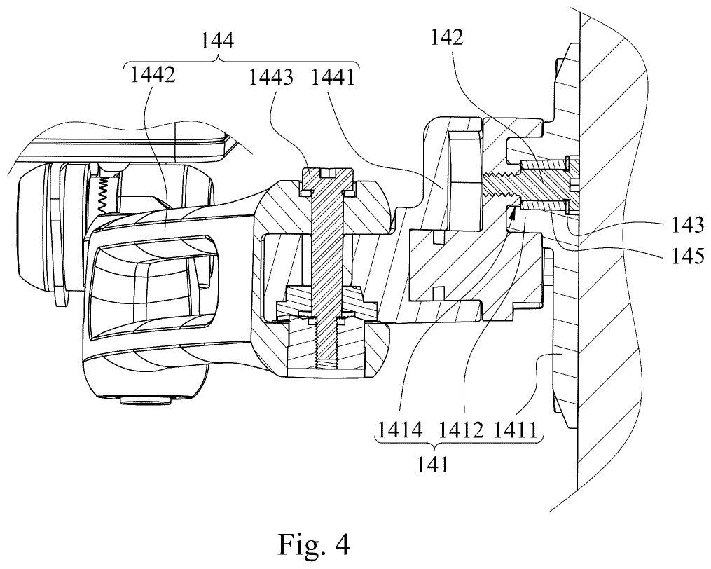

Reference is made to FIG. 1 to FIG. 4, wherein FIG. 4 is a cross-sectional view of the adjustable chair 100 of FIG. 1 along Line 4-4. The fixing plate 141 can further include a convex column 1412 and an accommodating slot 1413. The convex column 1412 can be a circular cylinder, and the convex column 1412 integrally protrudes from the plate body 1411 and is for the pivoted hole 1414 to penetrate there through. The accommodating slot 1413 is concavely disposed on the plate body 1411 and is towards each of the side panels 121, wherein the accommodating slot 1413 includes a slot base 1413a and is communicated with the pivoted hole 1414. The pin element 142 can pass through the accommodating slot 1413 and the pivoted hole 1414 in sequence and then be disposed in the pivoted hole 1414. In particular, the pin element 142 can include a head portion 1421, a non-screw rod portion 1422 and a screw rod portion 1423. The head portion 1421 is limited and positioned in the accommodating slot 1413, one end portion of the non-screw rod portion 1422 is connected to the head portion 1421, and the screw rod portion 1423 is connected to the other end portion of the non-screw rod portion 1422. Further, the head portion 1421 can be located in the accommodating slot 1413, one side of the head portion 1421 near the non-screw rod portion 1422 forces tightening the slot base 1413a of the accommodating slot 1413, and the screw rod portion 1423 protrudes out of the plate body 1411 through the pivoted hole 1414.

The armrest structure 140 can further include a ring assembly 145, the ring assembly 145 is disposed in the pivoted hole 1414, and the ring assembly 145 is sleeved and disposed on the pin element 142 and contacts the stabilizing element 143. In detail, the ring assembly 145 can be a hollow cylindrical element and is for the non-screw rod portion 1422 of the pin element 142 to be disposed therein. Further, because the inner diameter of the ring assembly 145 is slightly larger than the outer diameter of the non-screw rod portion 1422, the non-screw rod portion 1422 can rotate relative to the ring assembly 145. In the present embodiment, the ring assembly 145 can be a copper ring element, and the stabilizing element 143 can have an elasticity and include a nylon mainbody. In other words, the stabilizing element 143 can be a monolithic element made of the nylon, and the stabilizing element 143 will deform by forced tightening so as to absorb the vibration for the armrest structure 140. In other embodiment, the stabilizing element 143 can be made of any material having the elasticity, such as the plastic steel or the soft metal, but the present disclosure is not limited thereto.

As shown in FIG. 3, the armrest bracket 144 can further include a cover body 1441. The cover body 1441 includes a concave slot (reference number is omitted) and a screw hole (reference number is omitted), wherein the concave slot is concavely disposed on a surface of the cover body 1441, and the inner diameter of the concave slot is slightly larger than the convex column 1412 of the fixing plate 141. Accordingly, the convex column 1412 can be inserted in the concave slot. Further, because the screw hole is opened in the concave slot, the screw hole can be provided for the screw rod portion 1423 of the pin element 142 to be locked and positioned therein. Hence, the armrest bracket 144 can be disposed on the fixing plate 141.

When the backrest frame 120 and the fixing plate 141 rotate, because the non-screw rod portion 1422 of the pin element 142 and the head portion 1421 are both pivotally disposed on the fixing plate 141, the fixing plate 141 will not drive the pin element 142 to rotate, and thus the armrest structure 140 can rotate relative to the backrest frame 120. Further, the armrest bracket 144 can further include a frame body 1442 and a joint pin 1443. The frame body 1442 can be connected to the cover body 1441 by the joint pin 1443, and the frame body 1442 can rotate relative to the cover body 1441.

As shown in FIG. 2, the adjustable chair 100 can further include two linkage bars 170, and each of the linkage bars 170 can include a first screw rod 171, an arranging rod 172 and a second screw rod 173. Each of the first screw rods 171 is disposed in one of the armrest brackets 144. One end portion of the arranging rod 172 is for one end portion of the first screw rod 171 to be inserted therein. One end portion of the second screw rod 173 is disposed on the chair base 110, and the other end portion of the second screw rod 173 inserts in the other end portion of the arranging rod 172.

In particular, the two linkage bars 170 are respectively disposed on two sides of the adjustable chair 100 and can be used to support the armrest structure 140. The following description is based on one side view, but the present disclosure is not limited thereto. Each of the first screw rod 171 and the second screw rod 173 includes a screw thread, so the first screw rod 171 and the second screw rod 173 can be respectively screwed and disposed on two end portions of the arranging rod 172. The cover body 1441 can be connected to the other end portion of the first screw rod 171, and the said end portion of the second screw rod 173 is pivotally disposed on the chair base 110. When the backrest frame 120 and the armrest structure 140 rotate relative to the chair base 110, the first screw rod 171, the arranging rod 172 and the second screw rod 173 are driven to rotate simultaneously. It must be noted that when adjusting the position of the armrest structure 140, the sliding portion 1415 and the fixing element 1416 should be adjusted to move along the length extension direction of the side panel 121. At this time, the length of the linkage bar 170 should be adjusted correspondingly. For example, when the armrest structure 140 moves and is close to the chair base 110 along the length extension direction of the side panel 121, the first screw rod 171 and the second screw rod 173 can be rotated so as to insert deeply into the arranging rod 172, and then the length of the linkage bar 170 will be shortened. On the contrary, when the armrest structure 140 moves and is away from the chair base 110 along the length extension direction of the side panel 121, the first screw rod 171 and the second screw rod 173 can be rotated so as to gradually stay away from the arranging rod 172, and then the length of the linkage bar 170 will be increased. Further, the angle of the armrest structure 140 can be fine adjusted by shortening or increasing the length of the linkage bar 170. When the length of the linkage bar 170 is shortened, the angle relative to the chair base 110 of the armrest structure 140 is increased, correspondingly. When the length of the linkage bar 170 is increased, the angle relative to the chair base 110 of the armrest structure 140 is decreased.

Reference is made to FIG. 1 to FIG. 5, wherein FIG. 5 is a side schematic view of the adjustable chair 100 of FIG. 1. When the driving element 150 drives the backrest frame 120 to rotate by the driving rod 160, because the armrest structure 140 is pivotally disposed on the backrest frame 120, the armrest structure 140 and the backrest frame 120 may not rotate at the same angle.

In particular, when the adjustable chair 100 is in an initial state, the angle relative to the chair base 110 of the backrest frame 120 is 85 degrees, and the angle relative the chair base 110 of the armrest structure 140 is 5 degrees. During the reclining process of the adjustable chair 100, when the backrest frame 120 rotates, the armrest structure 140 also can rotate correspondingly, but the chair base 110 remains horizontal without being affected by the backrest frame 120 or the armrest structure 140. The rotating angle relative to the chair base 110 of the backrest frame 120 is the first angle A1 (in the present embodiment, because the chair base 110 remains horizontal, the rotating angle of the backrest frame 120 is the first angle A1), wherein the first angle A1 ranges from 0 degrees to 80 degrees, and thus the maximum angle relative to the chair base 110 of the backrest frame 120 can be 165 degrees. The rotating angle relative to the chair base 110 of each of the armrest structures 140 is the second angle A2 (in the present embodiment, because the chair base 110 remains horizontal, the rotating angle of each of the armrest structures 140 is the second angle A2), wherein the second angle A2 of each of the armrest structures 140 ranges from 0 degrees to 30 degrees, and thus the maximum angle relative to the chair base 110 of each of the backrest frames 120 can be 35 degrees. Further, the second angle A2 is smaller than the first angle A1 at any time, so the armrest structures 140 can be positioned to fit the hands of the user, and the ergonomics can be meet. Further, the positions of the armrest structures 140 can be adjusted without manual work, and it is favorable for enhancing the using convenience.

To sum up, the present disclosure has the advantages as follows. First, the armrest structures can be moved along with the rotation of the backrest frame, so the armrest structures can rotate to a proper position, and the using convenience and comfort thereof can be enhanced. Second, the stabilizing element has the elasticity, so it is favorable for avoiding the vibration when the armrest structure rotates.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. An adjustable chair, comprising:
a chair base;
a backrest frame pivotally disposed on the chair base, wherein the backrest frame comprises two side panels;
a backrest plate movably disposed on the backrest frame; and
two armrest structures respectively pivotally connected to the two side panels, and each of the two armrest structures comprising:
a fixing plate fixedly disposed on one of the two side panels and comprising a pivoted hole;
a pin element passing through and disposed in the pivoted hole;
a stabilizing element sleeved and disposed on the pin element; and
an armrest bracket locked and connected to the pin element;
wherein when the backrest frame rotates relative to the chair base at a first angle, the two armrest structures respectively rotate relative to the chair base at a second angle, and the second angle of each of the two armrest structures is smaller than the first angle.

2. The adjustable chair of claim 1, wherein the first angle ranges from 0 degrees to 80 degrees, and the second angle of each of the two armrest structures ranges from 0 degrees to 30 degrees.

3. The adjustable chair of claim 1, further comprising:
a driving element disposed on the chair base; and
a driving rod connected to the driving element and one of the two side panels;
wherein the driving element drives the driving rod to drive the backrest frame to rotate relative to the chair base.

4. The adjustable chair of claim 1, wherein each of the two side panels comprises two rails, each of the two fixing plates further comprises a plate body, two sliding portions and two fixing elements, the two sliding portions are connected to the plate body and respectively accommodated in the two rails, and the two fixing elements respectively pass through the plate body and are locked in the two sliding portions.

5. The adjustable chair of claim 1, further comprising:
two linkage bars, wherein each of the two linkage bars comprises:
a first screw rod disposed on one of the two armrest brackets;
an arranging rod, wherein the first screw rod is inserted in one end portion of the arranging rod; and
a second screw rod disposed on the chair base, wherein the second screw rod is inserted in the other end portion of the arranging rod.

6. The adjustable chair of claim 1, wherein each of the two armrest structures further comprises:
a ring assembly disposed in the pivoted hole, wherein the ring assembly passes through and is disposed in the pin element and contacts the stabilizing element.

7. An adjustable chair, comprising:
a chair base;
a backrest frame pivotally disposed on the chair base, wherein the backrest frame comprises two side panels; and
two armrest structures respectively pivotally connected to the two side panels, and each of the two armrest structures comprising:
a fixing plate fixedly disposed on one of the two side panels and comprising a pivoted hole;
a pin element passing through and disposed in the pivoted hole;
a stabilizing element sleeved and disposed on the pin element,
wherein the stabilizing element has an elasticity; and
an armrest bracket locked and connected to the pin element;
wherein when the stabilizing element is forced and deformed by the pin element, the backrest frame rotates relative to the chair base at a first angle, each of the two armrest structures is driven to rotate relative to the backrest frame at a second angle, and the second angle of each of the two armrest structures is smaller than the first angle.

8. The adjustable chair of claim 7, wherein the stabilizing element comprises a nylon mainbody.

9. The adjustable chair of claim 7, wherein the first angle ranges from 0 degrees to 80 degrees, and the second angle of each of the two armrest structures ranges from 0 degrees to 30 degrees.

10. The adjustable chair of claim 7, further comprising:
a driving element disposed on the chair base; and
a driving rod connected to the driving element and one of the two side panels;
wherein when the driving rod is driven by the driving element, the backrest frame rotates related to the chair base.
